(19) United States
(12) Patent Application Publication
(10) Pub. No.: US 2015/0256450 A1
(43) Pub. Date: Sep. 10, 2015

(54) Generating a Shape Graph for a Routing Table

(71) Applicants: Siyu YANG, (US); Zhiyong SHEN, (US); Peng XIE, (US); Yong TANG, (US); Ping LUO, (US); Junqing XIE, (US); Linpeng TANG, (US); Mihalis YANNAKAKIS, (US); Robert E TARJAN, (US); David LEE, (US); Hewlett-Packard Development Company, L. P., Houston, TX (US)

(72) Inventors: Siyu Yang, Princeton, NJ (US); Zhi-Yong Shen, Beijing (CN); Peng Xie, Beijing (CN); Tang Yong, Beijing (CN); Ping Luo, Beijing (CN); Jun-Qing Xie, Beijing (CN); Linpeng Tang, Princeton, NJ (US); Mihalis Yannakakis, New York, NY (US); Robert Tarjan, Princeton, NJ (US); David Lee, Palo Alto, CA (US)

(21) Appl. No.: 14/427,866

(22) PCT Filed: Sep. 28, 2012
(86) PCT No.: PCT/CN2012/082272

§ 371 Date: Mar. 12, 2015

(51) Int. Cl. H04L 12/753; H04L 12/24; H04L 12/44

(52) U.S. Cl. CPC H04L 45/48; H04L 12/44; H04L 41/0886

(57) ABSTRACT

A system and method for generating shape graphs for a routing table are described herein. The method includes splitting a binary trie representing a routing table of a router into a number of layers, wherein each layer includes a number of nodes. The method also includes, for each layer, determining a number of groups of isomorphic nodes and merging the isomorphic nodes within each group to generate a shape graph.

### BACKGROUND

It is often desirable to route Internet Protocol (IP) packets between various network locations within a networking environment. For example, any number of routers may be used to forward an IP packet from a network source to a network destination. Each router may include a routing table that contains a list of the routes to particular network destinations. In some cases, a core router may perform an IP lookup procedure for an incoming IP packet and forward the IP packet to a next router along the route to the IP packet's network destination. The IP lookup procedure may use a routing table that identifies the next router. As the sizes of networking environments continuously increase, the sizes of the routing tables for each of the routers in a typical network also increase. This may result in an increased memory requirements and longer lookup times for a typical router. Longer lookup times can result in reduced network throughput.

### BRIEF DESCRIPTION OF THE DRAWINGS

Certain examples are described in the following detailed description and in reference to the drawings, in which:

FIG. 1 is a block diagram of a networking environment that may be used to route packets between network locations;

FIG. 2 is a block diagram of a router that may be used to route a packet from a network source to a network destination;

FIG. 3 is a schematic of an exemplary routing table for a router;

FIG. 4 is a schematic of a binary trie representing the routing table;

FIG. 5 is a process flow diagram showing a method for generating a shape graph;

FIG. 6 is a schematic of a shape graph that is generated from the binary trie via the method discussed with respect to FIG. 5;

FIG. 7 is a generalized process flow diagram showing a method for generating shape graphs for a routing table; and

FIG. 8 is a block diagram showing a tangible, non-transitory, computer-readable medium that stores a protocol adapted to generate shape graphs for a routing table.

### DETAILED DESCRIPTION OF SPECIFIC EXAMPLES

Techniques described herein relate generally to the compression of a routing table for a router within a networking environment. More specifically, techniques described herein relate to the generation of a compressed routing table, referred to herein as a “shape graph,” by compressing a binary trie that represents a routing table for a router. The shape graph may be used to determine next hop information for a packet received by the router. The next hop information may relate to a next location to which a packet is to be routed on its way to a particular network destination. The next hop information for a specific packet may be determined by identifying a node corresponding to a longest matching prefix for the packet's network destination IP address within the shape graph.

According to techniques described herein, the shape graph may be stored in on-chip memory within a controller of the router, while the next hop information for the various nodes may be stored in off-chip memory within the router. For example, the on-chip memory may include fast, field-programmable gate array (FPGA) memory, while the off-chip memory may include slow, random access memory (RAM). Thus, the techniques described herein may be used to improve the routing procedure for a particular router by allowing for fast searching of the shape graph within the on-chip memory of a router, as well as efficient storage of the next hop information in the off-chip memory of the router.

In addition, due to the large size of the routing tables of many routers, the techniques described herein may be used to generate multiple shape graphs corresponding to a routing table of a router. For example, a shape graph may be determined for each layer of a multilayer binary trie representing a routing table.

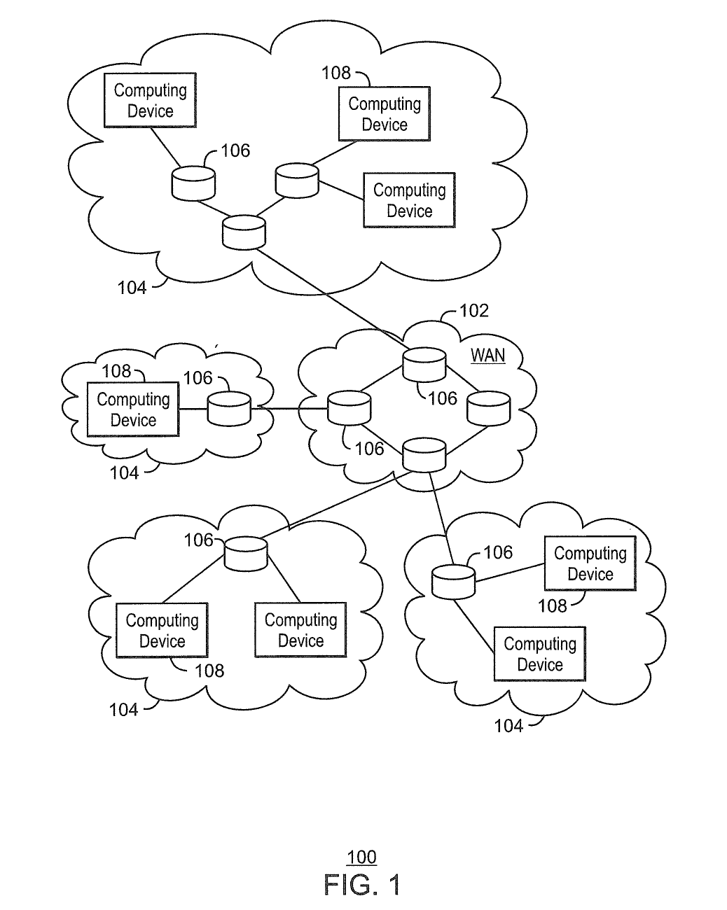

FIG. 1 is a block diagram of a networking environment 100 that may be used to route packets between network locations. The networking environment 100 may include a Wide Area Network (WAN) 102 that is communicatively coupled to a number of other networks 104 via a number of routers 106. The WAN 102 may be the Internet, and the data packets may be Internet Protocol (IP) packets. The other networks 104 within the networking environment 100 may include Local Area Networks (LANs), Metropolitan Area Networks (MANs), Virtual Private Networks (VPNs), other WANs, and the like.

Each network 104 may include any suitable number of computing devices 108. In addition, each network may include any suitable number of routers 106. The routers 106 may be used to route packets between the computing devices 108 included within each network 104. In some cases, a single router 106 may be used to route a packet from a source computing device 108 to a destination computing device 108 within a same network 104. In other cases, a number of routers 106 may be used to route a packet from a source computing device 108 to destination computing device 108. For example, each router 106 that is used to transfer the packet to the destination computing device 108 may determine a next router 106, e.g., next hop, to which the packet is to be sent during the routing procedure. A shape graph lookup procedure may be performed at each router 106 to determine the appropriate next hop for the packet by searching a shape graph.

It is to be understood the block diagram of FIG. 1 is not intended to indicate that the networking environment 100 is to include all of the components shown in FIG. 1 in every case. Further, any number of additional components may be included within the networking environment 100, depending on the details of the specific implementation.

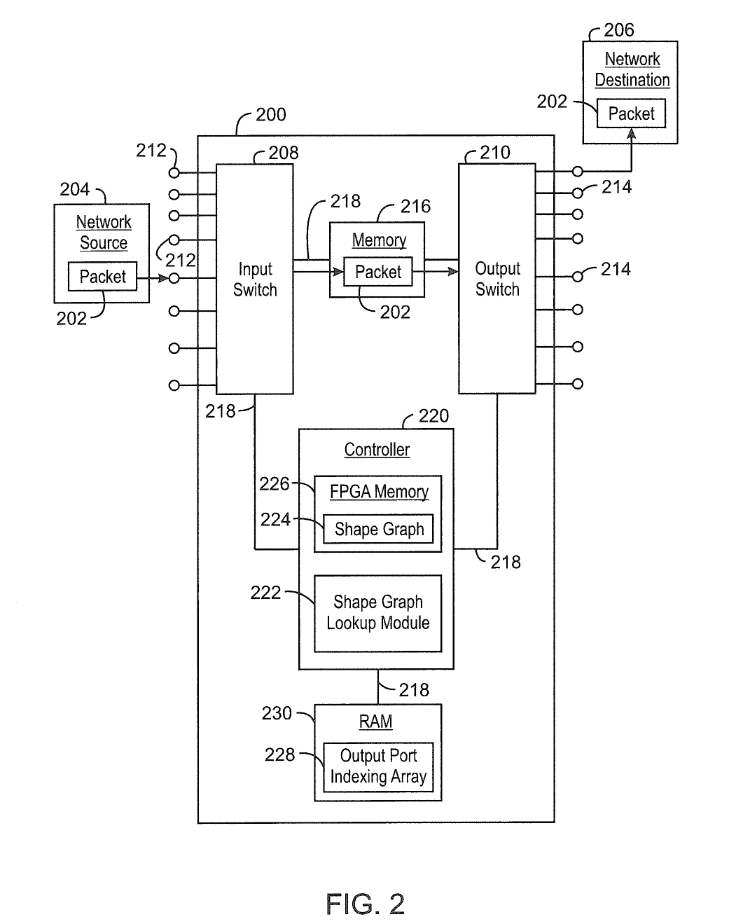

FIG. 2 is a block diagram of a router 200 that may be used to route a packet 202 from a network source 204 to a network destination 206. The router 200 may be implemented within the networking environment 100 discussed above with respect to Fig .1, for example. The network source 204 may be a source computing device, such as a desktop computer, laptop computer, or server, from which the packet 202 originates, or a network node, such as another router, that is along the packet's route to a destination computing device. In addition, the network destination 206 may be the destination computing device, such as a desktop computer, laptop computer, or server, to which the packet 202 is to be routed, or may be a network node, such as another router, that is along the packet's route to the destination computing device.

The router 200 may include an input switch 208 configured to receive the packet 202 from the network source 204, and an output switch 210 configured to send the packet to the network destination 206. The input switch 208 may include a number of input ports 212, and each input port 212 may be connected to a different network node, such as another router or a computing device. For example, the network source 204 may be connected to one of the input ports 212, as shown in FIG. 2. In addition, the output switch 210 may include a number of output ports 214, and each input port 214 may be connected to a different network node, such as another router or a computing device. For example, the network destination 206 may be connected to one of the input ports 214, as shown in FIG. 2. The router 200 may include an equal number of input ports 212 and output ports 214, as shown in FIG. 2, or may include more input ports 212 or more output ports 214, depending on the details of a specific implementation.

The router 200 may include a memory device 216 that is adapted to store the packet 202 received from the network source 204 until the appropriate network destination 206 has been determined. The memory device 216 may include random access memory (RAM), read only memory (ROM), flash memory, or any other suitable memory systems. The memory device 216 may be connected to the input switch 208 and the output switch 210 via a data bus 218. The data bus 218 may enable the transfer of the data packet 202 between the input switch 208 and the output switch 210.

Further, the router 200 may include a controller 220 that is adapted to direct the routing of the packet 202. The controller 220 may be connected to the input switch 208 and the output switch 210 via the data bus 218. Thus, the controller 220 may be configured to determine routing information relating to the data packet 202 as it is received at the input switch 208. Such routing information may be used by the controller 220 to perform a shape graph lookup procedure via a shape graph lookup module 222. According to examples described herein, the shape graph lookup module 222 may be any type of application or program that is adapted to perform such a shape graph lookup procedure. The shape graph lookup procedure may include searching a shape graph 224 that is stored in on-chip field-programmable gate array (FPGA) memory 226, e.g., FPGA memory that is stored within the controller 220. In some examples, the FPGA memory 226 may include any other suitable type of memory, such as RAM, ROM, flash memory, or the like. The shape graph 224 may be searched to determine next hop information based on a longest matching prefix for the IP address of the network destination 206 referred to in the packet's routing information. The next hop information may include an output port index for routing the packet 202.

Once the output port index has been determined, the shape graph lookup module 222 may determine a corresponding output port 214 for routing the packet 202 to the appropriate network destination 206. This may be accomplished by searching an output port indexing array 228 stored within off-chip RAM 230, e.g., RAM that is stored outside of the controller 220. The RAM 230 may be accessed by the shape graph lookup module 222 via the data bus 218. The RAM 230 may include, for example, dynamic RAM (DRAM), static RAM (SRAM), or the like. Further, in some examples, the RAM 230 may include any other suitable type of memory, such as ROM, flash memory, or the like.

The controller 220 may then send the information relating to the appropriate network destination 206 to the output switch 206. The output switch 206 may retrieve the packet 202 from the memory 216, and forward the packet 202 to the network destination 206.

It is to be understood the block diagram of FIG. 2 is not intended to indicate that the router 200 is to include all of the components shown in FIG. 2 in every case. Further, any number of additional components may be included within the router 200, depending on the details of a specific implementation.

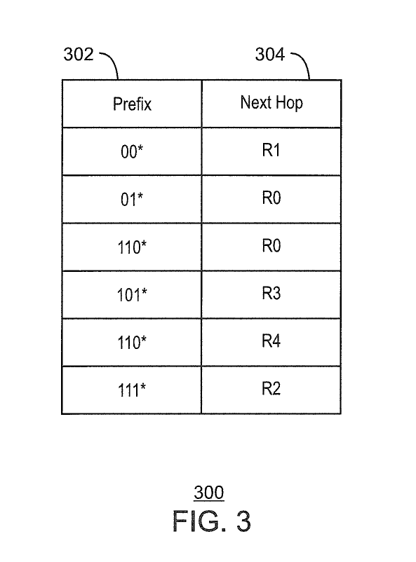

FIG. 3 is a schematic of an exemplary routing table 300 for a router. The router may include the router 200 discussed above with respect to FIG. 2, for example. The routing table 300 may include a number of prefixes 302, wherein each prefix represents an IP address of a network node that is communicatively coupled to the router via an output port. In addition, the routing table 300 may include next hop information 304 corresponding to each prefix 302. The next hop information 304 may include information relating to the specific output port of the network node corresponding to the prefix 302. For example, as shown in FIG. 3, the prefix 302 denoted by “101*” within the routing table 300 may correspond to an output port within the router denoted by “R3.” In some cases, more than one prefix 302 may correspond to a same output port. For example, as shown in FIG. 3, the prefixes 302 denoted by “01*” and “110*” may both correspond to an output port denoted by “R0.”

According to techniques described herein, the routing table 300 may be used to determine an output port corresponding to an appropriate network destination for an internet protocol (IP) packet via an IP lookup procedure. This may be accomplished by determining a prefix 302 for the IP packet, wherein the prefix 302 is the longest matching prefix corresponding to the network destination IP address of the IP packet. The routing table 300 may then be used to identify the output port for the network destination based on the next hop information 304.

In many cases, the routing table 300 for a router includes a large number of prefixes. As a result, the routing table 300 may consume a large amount of memory space within the router. This may significantly increase lookup time and reduce the throughput for the IP lookup procedure. Thus, compression of the routing table 300 may be desirable.

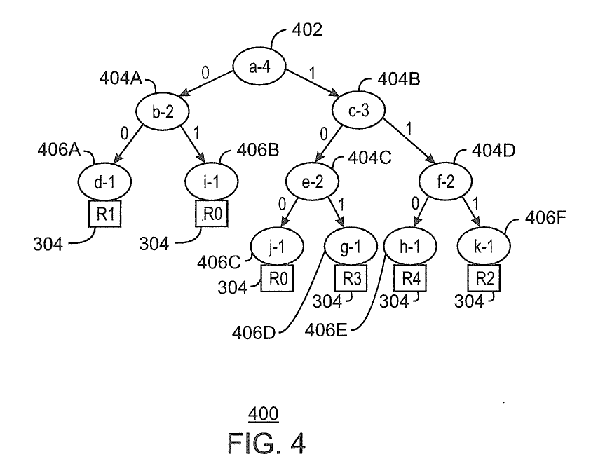

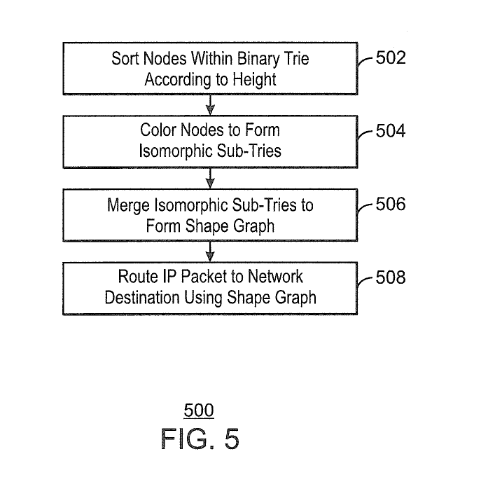

FIG. 4 is a schematic of a binary trie 400 representing the routing table 300. The binary trie 400 may be a binary tree with back-edges that may be used to organize the prefixes 302 and the next hop information 304 within the routing table 300. The binary trie 400 may include a root node 402 located at the top of the binary trie 400, any number of intermediary nodes 404 branching off the root node 402, and any number of leaf nodes 406 located at the bottom of the binary trie 400 and branching off the intermediary nodes 404 or the root node 402. Construction of the binary trie 400 may be performed by merging the prefixes 302 within the routing table 300 such that the root node 402 corresponds to the starting point of the IP lookup procedure for the IP packet, and each leaf node 406 corresponds to specific next hop information 304 relating to a longest matching prefix obtained by walking from the root node 402 to the leaf node 406 based on the network destination IP address of the IP packet. The binary trie 400 may occupy a large amount of memory space within the router. Thus, it may be desirable to compress the binary trie 400 to generate one or more shape graphs, as discussed further below with respect to FIGS. 5, 6, and 7.

In order to generate the shape graph, the binary trie 400 may be compressed. This may be accomplished by traversing all the nodes 402, 404, and 406 within the binary trie 400 starting from the bottom of the binary trie 400, and assigning an indicator to each node 402, 404, or 406. The indicator may be used to merge the nodes 402, 404, and 406 into a number of node groups, referred to herein as “sub-tries,” wherein each sub-trie includes identical, or isomorphic, nodes 402, 404, or 406. Each sub-trie may include any number of nodes 402, 404, or 406, or, in some cases, may include only one node 402, 404, or 406. Further, according to the example shown in FIG. 4, the indicator is represented by a real number in [1, 2, . . . , n), wherein n denotes the total number of sub-tries. However, it is to be understood that any suitable type of indicator may be used.

As discussed above, traversal of the nodes 402, 404, and 406 may be performed starting from the bottom of the binary trie 400, i.e., starting with the leaf nodes 406. All the leaf nodes 406 may be assigned a same indicator, e.g., the indicator “1” as shown in FIG. 4. Then, moving upwards from the leaf nodes 406, the left and right intermediary nodes 404 may be examined, and groups of isomorphic intermediary nodes 404 may be assigned a same indicator. For example, as shown in FIG. 4, the intermediary nodes 404A, 404C, and 404D may be isomorphic and, thus, may be assigned a same indicator, i.e., the indicator “2.” Once the root node 402 is reached, e.g., once all of the nodes 402, 404, and 406 have been traversed, all nodes 402, 404, or 406 of the same indicator, e.g., all the sub-tries, may be merged to obtain the shape graph. The specific method by which the shape graph may be generated is discussed further below with respect to FIG. 5.

FIG. 5 is a process flow diagram showing a method 500 for generating a shape graph. The method 500 may be used, for example, to generate a shape graph for the binary trie 400 representing the routing table 300 discussed with respect to FIGS. 3 and 4. Further, the indicators for the nodes may be referred to herein as “colors,” and the process of assigning indicators to the nodes may be referred to herein as “coloring” the nodes.

According to techniques described herein, due to the large size of the binary trie for a routing table, the binary trie may be split into a number of layers prior to the execution of the method 500. Then, a separate shape graph may be determined for each layer of the multi-layer binary trie according to the method 500. As an example, for Internet Protocol version 4 (IPv4) applications, a 32-bit binary trie may be split into five layers, including a 9-bit layer, a 6-bit layer, a 4-bit layer, a 3-bit layer, and a 10-bit layer. As another example, for Internet Protocol version 6 (IPv6) applications, a 64-bit binary trie may be split into five layers, including three 12-bit layer and two 14-bit layers.

The method begins at block 502, at which nodes within a binary trie representing a routing table are sorted according to height. This may be accomplished through two traversals of the binary trie. A post-order traversal of the binary trie may be used to calculate the height of every node, and another traversal of the binary trie may be used to perform a counting sort over all nodes according to their calculated heights. Such a sorting process may be performed according to the following code fragment, which represents an algorithm that is linear in time and space.

```
sortbyheight(root)
      set count[ ] array all 0;
      postorder(root);
      for (i=1 to root.height)
            count[i]←count[i]+count[i−1];
      countsort(root);
      clear list[ ]array;
      return list[ ]
postorder(node)
      if (node is NULL) then return −1;
      node.height ← max{postorder(node.left),
      postorder(node.right)}+1;
      count[node.height]++;
      return node.height
countsort(node)
      if (node is NULL) then return;
      count[node.height]−−;
      list[count[node.height]]=node;
      countsort(node.left);
      countsort(node.right)
```

In some cases, two separate traversals of the binary trie may be avoided by partitioning the nodes on-the-fly. Let Sᵢ be the set of nodes with height i. Initially, all the leaf nodes may be inserted into S₀. During the node coloring process, when a node v is assigned a color 1, the node v′s sibling node μ may be checked. If the sibling node u has been colored, then node v and node u′s parent node p may be added into the set Sᵢ₊₁. This partitioning procedure can be performed at the same time as the coloring procedure with one auxiliary array, and it may be performed within a constant time for every node in the trie.

At block 504, the nodes within the binary trie are colored to form isomorphic sub-tries. Every node within the binary trie may be represented as a triple, including the value (has-entry, left-color, right-color), which specifies whether the node corresponds to a prefix, the color of the node branching to the left, and the color of the node branching to the right, respectively. The isomorphic sub-tries may be determined by performing three partitioning procedures. The first partitioning procedure may involve partitioning nodes into two groups by their has-entry value, which may be equal to 0 or 1. The second partitioning procedure may involve partitioning nodes within each group according to their left colors, and the third partitioning procedure may involve partitioning nodes with the same has-entry and left color by their right colors. The second and third partitioning procedures, which involve grouping nodes with the same left color and right color pairs together and assigning a distinct color to the group of nodes, is described further below.

The colors of the nodes may be represented by real numbers in {1,2, . . . , n}. An array H with n entries may be constructed, where entry i is a pointer to a linked list of color pairs for color i. A linked list L may also be constructed to record the occupied entries by the left colors in H. For the second partitioning procedure, all pairs of colors may be inserted into the array in turn. When a color pair (a, b) is inserted, the entry a in the array H may be checked. If the entry a is associated with an empty linked list, the pair may be assigned as the first item of the linked list, pointed to from entry a in H, and a may be inserted into L. Otherwise, the color pair may be inserted into the linked list from entry a in H, and L may remain unchanged. After all the pairs may been inserted into H, a linked list L of all the left colors is obtained, as well as an array H storing all the pairs. For every item i in L, the linked list of pairs from entry i in H may be examined, and the same process may be repeated according to the right colors in order to obtain a linked list R of right colors.

From the array H and the linked list R, the pairs that have the same left and right colors may be collected into groups, and a distinct color may be assigned to each group of pairs, or sub-trie. Such a coloring procedure may be performed according to the following code fragment, which represents an algorithm that is linear in time and space.

Data structures:

```
S₀, S₁, S₂ ,...: Sets of nodes of different height. All leaf nodes are in S₀
initially, other sets are all empty.
Aₗ[0 ... n], Aᵣ[0 ... n]: Aₗ([i](Aᵣ[i]) is the linked list of all nodes with
left(right) child color i.
Lₗ, Lᵣ: Linked list of all occupied indices in Aₗ and Aᵣ.
color_trie( )
color←0;
h←0; //current height
Lₗ, Lᵣ←NULL;
initialize Aₗ[ ],Aᵣ[ ] with all NULL entries;
initialize S₀ with all leaf nodes;
while (root.color is NULL) do
      for (bool in {true, false})
            for (all node in Sₕ)
                  if (node.has_entry!= bool) then continue;
                  if (Aₗ[node.left] is NULL) then
                        create an empty linked list on Aₗ[node.left];
                        insert node.left unto L_{l;}
                  endif
                  insert node into Aₗ[node.left];
            endfor
            for (all index_left in Lₗ)
                  for (all node in Aₗ[index_left])
                        if (Aᵣ[node.right] is NULL) then
                              create an empty linked list on
                              Aᵣ[node.right];
                              insert node.rightinto Lᵣ;
                        endif
                        insert node into Aᵣ[node.right];
                  endfor
                  for (all index_right in Lᵣ)
                        for (all node in Aᵣ[index_right])
                              node.color ← color;
                              if (node.sibling.coloris not NULL)
                              then Sₕ₊₁ ← Sₕ₊₁ ∪ {node.parent};
                        endfor
                        Aᵣ[index_right] ← NULL;
                        color++;
                  endfor
                  Lᵣ←NULL;
                  Aₗ[index_left] ← NULL;
            endfor
            Lₗ←NULL;
      endfor
      h←h+1;
endwhile
```

At block 506, isomorphic sub-tries are merged to form a shape graph. In other words, nodes of the same color may be merged to obtain the shape graph. The shape graph may be stored in on-chip memory, such as a fast-processing FPGA memory. According to the example described herein, has-entry nodes, i.e., nodes within the shape graph that relate to next hop information, may be referred to as “black nodes,” and the other nodes may be referred to as “white nodes.” The corresponding next hop information, i.e., port number information, for each black node may be stored in an array in off-chip memory, such as RAM. In addition, in some cases, each node of the shape graph may store the number of black nodes of the original sub-trie that is rooted at the node.

At block 508, an IP packet is routed to a network destination using the shape graph. Specifically, an output port number corresponding to the network destination for the IP packet may be determined via a shape graph lookup procedure, and the router may forward the IP packet to the network destination via the particular output port number.

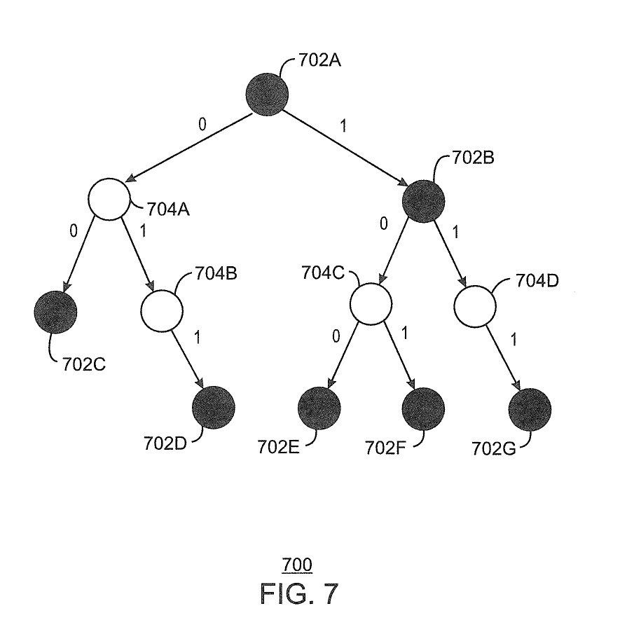

The shape graph lookup procedure may involve walking through the shape graph according to the network destination IP address of the IP packet while keeping track of a counter value, beginning at the root node with a counter value of 0. When a right node is encountered, i.e., when an input of 1 is received, the counter value may be increased by the number of black nodes associated with the same source node. In addition, the counter value may be increased by 1 each time a black node is encountered, independently of whether the black node is a right node or a left node, e.g., whether an input of 1 or 0 is received. The counter value at the last visited black node may be continuously updated and stored. This counter value may represent the output port index in the output port indexing array that corresponds to the appropriate output port number for the IP packet. Alternatively, if the walk ends at a black node, the final counter value may be used as the output port index. This shape graph lookup procedure is discussed further below with respect to the exemplary shape graph 700 shown in FIG. 7.

It is to be understood that the process flow diagram of FIG. 5 is not intended to indicate that the steps of the method 500 are to be executed in any particular order, or that all of the steps of the method 500 are to be included in every case. Further, any number of additional steps not shown in FIG. 5 may be included within the method 500, depending on the details of the specific implementation. For example, the method 500 may allow for pipeline processing of IP packets within the shape graph. Such pipeline processing may be performed, for example, by beginning execution of the method 500 for a new IP packet approximately every clock cycle.

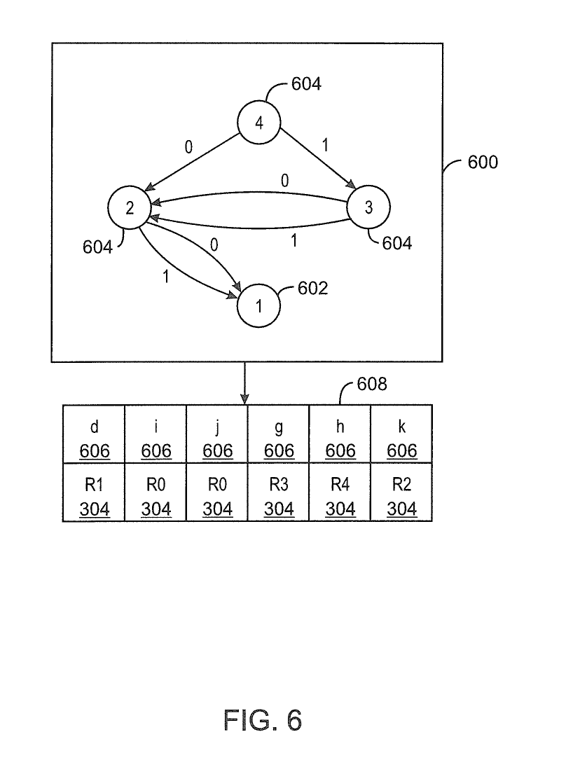

FIG. 6 is a schematic of a shape graph 600 that is generated from the binary trie 400 via the method 500 discussed with respect to FIG. 5. In some cases, only one shape graph 600 may be generated from the binary trie 400, as shown in FIG. 6. However, in other cases, the binary trie 400 may be split into a number of layers, and multiple shape graphs 600 may be generated from the multi-layer binary trie 400, as discussed above with respect to FIG. 5.

The shape graph 600 may include a black node 602 and a number of white nodes 604. Each of the white nodes 604 may represent one or more isomorphic sub-tries within the binary trie 400. The black node 602 may represent the leaf nodes 406 within the binary trie 400. In addition, each of the black nodes 602 may include one or more output port indexes 606, wherein each output port index 606 corresponds to a particular prefix. The output port index 606 may point to specific next hop information 304 that is stored within an output port indexing array 608. The next hop information 304 may include the output port number of a particular network destination. Thus, the shape graph 600 may be used to identify an output port number corresponding to the longest matching prefix for the network destination IP address of an IP packet. The output port number may be determined according to the shape graph lookup procedure, as discussed further below with respect to FIG. 7.

FIG. 7 is an exemplary shape graph 700 for which the shape graph lookup procedure may be performed. The shape graph 700 may include a number of black nodes 702 and a number of white nodes 704. The shape graph lookup procedure may be performed for an IP packet with an input IP address of “110.” Accordingly, traversal of the shape graph 700 may begin with the black node 702A, i.e., the root node, and move to the black node 702B. At the black node 702B, the longest matching prefix is 1*, and the output port index is 3. The output port index of 3 corresponds to a counter value of 3, which is obtained by adding 1 to the counter value for the black node 702A and adding 2 to the counter value for the black nodes 702C and 702D. A value of 1 may be added for each of the black nodes 702C and 702D because an input value of 1 was received, and the black nodes 702C and 702D are associated with the same source node as the black node 702B, i.e., the black node 702A.

At the black node 702B, an input of 1 is received, and the shape graph lookup procedure moves to the white node 704D. At the white 704D, the counter value is increased to 6. The counter value of 6 is obtained by adding 1 to the counter value for the black node 702B and adding another 2 to the counter value for the black nodes 702E and 702F, which are associated with the same source node as the white node 704D, i.e., the black node 702B.

The shape graph lookup procedure ends at the next step upon receiving an input of 0, since there is no left node branching off the white node 704D. Moreover, because the last node is a white node, i.e., the white node 704D, the value of the output port index may be the value of the output port index at the last visited black node, i.e., the black node 702B. Therefore, the output port index may be 3, corresponding to a longest matching prefix of 1*.

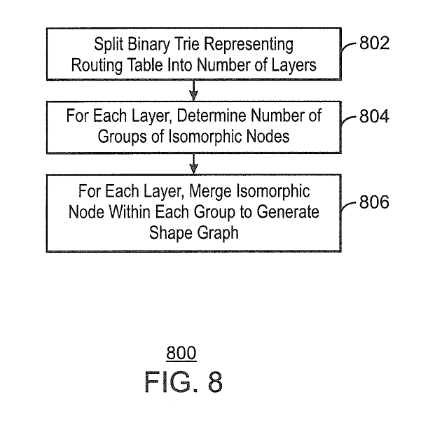

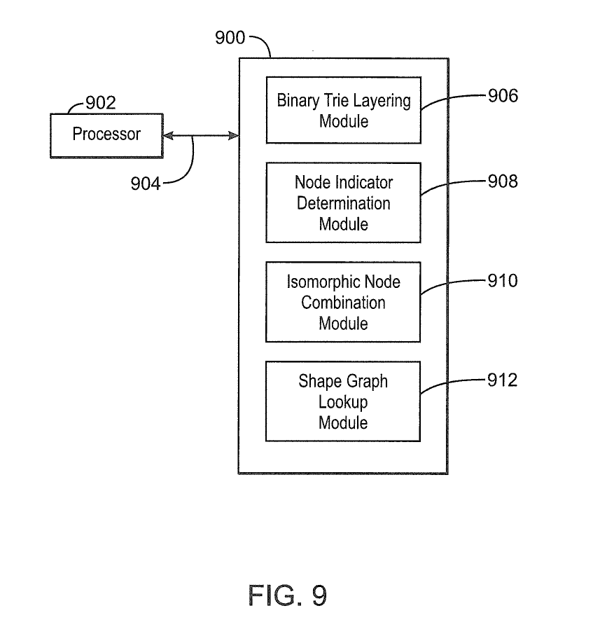

FIG. 8 is a generalized process flow diagram showing a method 800 for generating shape graphs for a routing table. The method begins at block 802, at which a binary trie representing a routing table of a router may be split into a number of layers. Each layer includes a number of nodes. The number of layers, as well as the height of each layer, may be determined based on the size of the binary trie, such as, for example, the number of bits included within the binary trie.

At block 804, for each layer, a number of groups of isomorphic nodes are determined. The isomorphic nodes may be identical nodes. For example, the nodes may be of an identical type, i.e., white node or black node, and may branch from a previous node in response to an identical input, i.e., 0 or 1.

At block 806, for each layer, the isomorphic nodes within each group are merged to generate a shape graph. The shape graph for each layer may include a number of prefixes relating to Internet Protocol (IP) addresses of network destinations within a networking environment of the router. The shape graphs may be stored in an on-chip memory within a controller of the router, while next hop information relating to the shape graphs may be stored in an off-chip memory outside the controller of the router.

It is to be understood that the process flow diagram of FIG. 8 is not intended to indicate that the steps of the method 800 are to be executed in any particular order, or that all of the steps of the method 800 are to be included in every case. Further, any number of additional steps not shown in FIG. 8 may be included within the method 800, depending on the details of the specific implementation. For example, an IP packet may be routed using any of the shape graphs. The IP packet may be received from a network source at the router, and a longest matching prefix corresponding to an IP address of a network destination for the IP packet may be determined within any of the shape graphs. An output port index corresponding to the longest matching prefix may be identified, and an output port number for the network destination may be identified based on the output port index. The IP packet may then be forwarded to the network destination via the identified output port number of the router. Further, in some cases, multiple IP packets may be routed at the same time according to a pipeline processing procedure.

FIG. 9 is a block diagram showing a tangible, non-transitory, computer-readable medium that stores a protocol adapted to generate shape graphs for a routing table. The tangible, non-transitory, computer-readable medium 900 may be accessed by a processor 902 over a computer bus 904. Furthermore, the tangible, non-transitory, computer-readable medium 900 may include code to direct the processor 902 to perform the steps of the current method.

The various software components discussed herein may be stored on the tangible, non-transitory, computer-readable medium 900, as indicated in FIG. 9. For example, a binary trie layering module 906 may be adapted to split a binary trie into a number of layers based on the size of the binary trie. A node indicator determination module 908 may be adapted to assign indicators to each node within each layer of the binary trie, wherein isomorphic nodes are assigned a same indicator. An isomorphic node combination module 910 may be adapted to merge isomorphic nodes, i.e., nodes that have been assigned a same indicator, to generate a shape graph for each layer. The shape graphs may represent a compressed version of the multilayer binary trie. In addition, a shape graph lookup module 912 may be adapted to route a data packet using any of the generated shape graphs.

It is to be understood that FIG. 9 is not intended to indicate that all of the software components discussed above are to be included within the tangible, non-transitory, computer-readable medium 900 in every case. Further, any number of additional software components not shown in FIG. 9 may be included within the tangible, non-transitory, computer-readable medium 900, depending on the details of the specific implementation.

The present examples may be susceptible to various modifications and alternative forms and have been shown only for illustrative purposes. For example, the present techniques support both reading and writing operations to a data structure cache. Furthermore, it is to be understood that the present techniques are not intended to be limited to the particular examples disclosed herein. Indeed, the scope of the appended claims is deemed to include all alternatives, modifications, and equivalents that are apparent to persons skilled in the art to which the disclosed subject matter pertains.

What is claimed is:

1. A method for generating shape graphs for a routing table, comprising:
splitting a binary trie representing a routing table of a router into a plurality of layers, wherein each layer comprises a plurality of nodes;
for each layer, determining a plurality of groups of isomorphic nodes; and
for each layer, merging the isomorphic nodes within each of the plurality of groups to generate a shape graph.

2. The method of claim 1, comprising splitting the binary trie into the plurality of layers based on a number of bits included within the binary trie.

3. The method of claim 1, wherein the shape graph for each layer comprises a plurality of prefixes relating to Internet Protocol (IP) addresses of network destinations within a networking environment of the router.

4. The method of claim 1, comprising routing an Internet Protocol (IP) packet using any of the shape graphs.

5. The method of claim 4, wherein routing the IP packet comprises:
receiving the IP packet from a network source at the router;
determining a longest matching prefix corresponding to an IP address of a network destination for the IP packet within any of the shape graphs;
identifying an output port index corresponding to the longest matching prefix;
identifying an output port number for the network destination based on the output port index; and
forwarding the IP packet to the network destination via the identified output port number of the router.

6. The method of claim 4, comprising performing pipeline processing to route a plurality of IP packets based on any of the shape graphs.

7. The method of claim 1, comprising storing next hop information relating to the shape graph for each layer in an off-chip memory of the router.

8. The method of claim 1, wherein determining the plurality of groups of isomorphic nodes for a layer comprises:
assigning an indicator to each node within the layer; and
combining nodes with a same indicator.

9. A router, comprising:
an input port configured to receive an Internet Protocol (IP) packet from a network source;
a controller configured to determine a output port corresponding to a network destination of the IP packet using any of a plurality of shape graphs stored in an on-chip memory of the controller and any of a plurality of corresponding output port indexing arrays stored in an off-chip memory outside the controller, wherein the plurality of shape graphs are generated for each of a plurality of layers of a binary trie by determining a plurality of groups of isomorphic nodes for each layer and merging the isomorphic nodes within each of the plurality of groups for each layer; and
the output port configured to route the IP packet to the network destination.

10. The router of claim 9, wherein the controlled is configured to perform pipeline processing of a plurality of data packets using any of the generated shape graphs.

11. The router of claim 9, wherein the on-chip memory comprises field-programmable gate array (FPGA) memory within the controller.

12. The router of claim 9, wherein the off-chip memory comprises dynamic random access memory (DRAM) outside the controller.

13. The router of claim 9, wherein the each shape graph within the on-chip memory comprises a corresponding output port indexing array within the off-chip memory, and wherein the output port indexing array is used to determine the output port for the network destination based on an output port index identified from the shape graph.

14. The router of claim 9, wherein each shape graph comprises a plurality of prefixes relating to IP addresses.

15. The router of claim 14, wherein the controller is configured to determine the output port corresponding to the network destination of the IP packet by identifying a longest matching prefix corresponding to an IP address of the network destination of the IP packet within any of the plurality of shape graphs.

16. A tangible, non-transitory, computer-readable medium comprising code configured to direct a processor to:
split a binary trie representing a routing table of a router into a plurality of layers, wherein each layer comprises a plurality of nodes;
for each layer, assigning an indicator to each of the plurality of nodes; and
for each layer, merge any of the plurality of nodes comprising a same indicator to generate a shape graph.

17. The tangible, non-transitory, computer-readable medium of claim 16, wherein the tangible, non-transitory, computer-readable medium comprises code configured to direct a processor to split the binary trie into the plurality of layers based on a size of the binary trie and a type of networking environment in which the router is located.

18. The tangible, non-transitory, computer-readable medium of claim 16, wherein the shape graph for each layer comprises a plurality of prefixes relating to Internet Protocol (IP) addresses of network destinations within a networking environment of the router.

19. The tangible, non-transitory, computer-readable medium of claim 16, wherein the tangible, non-transitory, computer-readable medium comprises code configured to route a data packet to a network destination based on any of the shape graphs.

20. The tangible, non-transitory, computer-readable medium of claim 19, wherein routing the data packet to the network destination based on any of the shape graphs comprises:
receiving the data packet from a network source at the router;
determining a longest matching prefix corresponding to an address of the network destination for the data packet within any of the shape graphs;
identifying an output port index corresponding to the longest matching prefix;
identifying an output port number for the network destination based on the output port index; and
forwarding the data packet to the network destination via the identified output port number of the router.
